(19) United States
(12) Patent Application Publication
(10) Pub. No.: US 2014/0268635 A1
(43) Pub. Date: Sep. 18, 2014

(54) PHOSPHORIC HORTICULTURAL LIGHT

(71) Applicant: Valoya Oy, Helsinki (FI)

(72) Inventors: LARS AIKALA, Lapinkyla (FI); ILKKA KIVIMAKI, Helsinki (FI); JUHA RANTALA, Singapore (SG)

(73) Assignee: Valoya Oy, Helsinki (FI)

(21) Appl. No.: 14/154,759

(22) Filed: Jan. 14, 2014

Related U.S. Application Data
(60) Provisional application No. 61/781,235, filed on Mar. 14, 2013.

(51) Int. Cl. F21K 99/00

(52) U.S. Cl. CPC F21K 9/56
USPC 362/84

(57) ABSTRACT

A horticultural light for use in green houses and growth chambers of plants, includes multiple LEDs (Light Emitting Diode) configured to excite a single remote phosphor up-conversion unit, typically realized on a replaceable cover glass of the light. The LED emitters are also replaceable, and preferably attached to a trunk, and not a circuit board. The distance between the plurality of LEDs and the remote phosphor up-conversion unit is configured so that the temperature of the remote phosphor up-conversion unit is 40±10 C.°, and the LED is at 130±30 C.° temperature. The combination of being able to control a separation between the remote phosphor up-conversion unit and the LEDs and having multiple LEDs emit to a single remote phosphor up-conversion unit has a great synergistic advantage: this provides a very energy efficient way of designing complex emission spectra that can be used on an industrial scale.

### TECHNICAL FIELD OF INVENTION

The invention relates to agriculture. More specifically, the invention relates to horticultural lights used in green houses and growth chambers of plants.

### BACKGROUND

Many of the plants people use for food, decoration or other purposes are farmed industrially in greenhouses year round. Artificial lighting is needed in these greenhouses and the prior art comprises for example fluorescent tubes and LEDs (Light Emitting Diode) that have been used for this purpose.

One of the leading publications in this field is that of the inventor, WO 2011/033177, which describes a LED based greenhouse light with a phosphoric wavelength up-converter. These lights have a preferable spectrum for plant growth. This prior art has a disadvantage. The phosphoric material C attached to the LED chip overheats frequently, which causes deterioration in the emission performance and spectrum. This document is cited here as reference.

US 2009/0231832 A1 describes a conventional Solid state lamp with a UV LED and a phosphor converter layer. This lamp is not suited to horticultural cultivation, rather it is directed to emitting spectrophotometrically calibrated colours. This document is cited here as reference.

US 2006/0245174A1 describes a system where the thermodynamics of a LED luminaire are managed. This is achieved with light sensors that provide feedback to the light emitter. Electronic feedback systems have a disadvantage in a greenhouse system of large scale, as it is prone to failures. This document is cited here as reference.

The journal article “Improved Performance White LED” covers aspects of the logic and history behind the remote phosphor configured LEDs. The white LEDs of this publication may have a high performance on some device metrics, but they suffer from the disadvantage of being unsuitable to horticultural cultivation on a large scale. This document is cited here as reference.

WO2010/053341 presents a phosphor conversion light emitting diode for meeting photomorphogenetic needs of plants. In this publication, FIG. 2, multiple phosphors are on a lid that covers a LED. The emitter is intended for horticulture. This solution also suffers from the disadvantage of being unsuitable to horticultural cultivation on a large scale.

### SUMMARY

The invention under study is directed towards a system and a method for effective LED illuminated agriculture of plants, where a part of the emitted spectrum is up converted by a phosphor material.

A further object of the invention is to present a horticultural LED device which has a remote phosphor wavelength up conversion unit with a minimum number of electronic components.

An even further objective of the invention is to provide a horticultural light that provides a spectrally complex, but yet spatially uniform emission.

An even further objective of the invention is to provide a horticultural light that provides a spectrally complex and spatially uniform emission with high power efficiency.

One aspect of the invention involves a greenhouse light that has multiple LEDs (Light Emitting Diode) configured to excite a single remote phosphor up-conversion unit. The remote phosphor unit is typically realised on the cover glass of a horticultural light and at least two LED emitters are housed underneath this cover glass. Typically the cover glass is also transparent to some wavelengths emitted by the LEDs.

According to one aspect of the invention the distance between the cover glass and the LEDs can be tuned. In some cases it is tuned so that the temperature of the remote phosphor up-conversion unit is 40±10 C.°, and said LED is at 130±30 C.° temperature. At these temperatures both components work optimally and save energy.

In one aspect of the invention the LEDs are wired to electrical conductors without a circuit board with plain wire conductors and are attached to the trunk of the horticultural light.

In another aspect of the invention, the remote phosphor up-conversion unit has one or multiple phosphoric materials. Further, one or more phosphoric materials may be realised as laminar layers into the remote phosphor up-conversion unit. Even further, at least two phosphoric materials can be layered on top of one another, with a separation or no separation in between them into or on top of the remote phosphoric conversion unit.

In an even further aspect of the invention, a reflector may be placed alongside the one or more LEDs to reflect light back into the remote phosphor up-conversion unit that has been reflected or back scattered back to the LEDs, from the remote phosphor up-conversion unit or elsewhere.

The combination of being able to control a separation between the remote phosphor up-conversion unit and the LEDs and having multiple LEDs emit to a single remote phosphor up-conversion unit has a great synergistic advantage: this provides a very energy efficient way of designing complex emission spectra that can be used on an industrial scale. These inventive horticultural lights are also far cheaper to produce as they can be produced from more fundamental raw materials, namely just diodes and phosphoric material. The cost of raw diodes and raw phosphoric material is considerably smaller than producing a horticultural light from lighting subcomponents that have any level of system integration in them. The laminar structure of the remote phosphor up-conversion unit produces a spatially homogeneous emission spectrum, which is very desirable in horticultural applications, where the plant should receive the same spectrum all over itself. The direct wiring of LEDs makes the invention very price competitive on an industrial scale. The reflectors in between the LEDs that reflect backscattered or reflected light back into the remote phosphor up-conversion unit increases the power efficiency of the horticultural light further still by providing optical feedback. The inventive differences and advantages bring about one single synergistic advantage that is greater than the sum of its parts: The invention amounts to an industrially scalable high power efficiency agricultural lighting system that can be used with very high spatial spectral definition in a robust way that involves less components than prior art systems.

Horticultural light in accordance with the invention comprises at least one LED and at least one remote phosphoric material in a remote phosphor up-conversion unit for wavelength conversion and a mechanical trunk, characterised in that,
a plurality of LEDs and a remote phosphor up-conversion unit are configured to be separated by air, gas and/or free space,
said remote phosphor up-conversion unit is configured to receive light emission from said plurality of LEDs, and
said remote phosphor up-conversion unit is configured to absorb said light emission and up convert said emission to longer wavelengths,
said emission from said plurality of LEDs and/or said up-converted emission is configured to be emitted on at least one plant.

Use of the aforementioned horticultural light in plant cultivation is also in accordance with the invention.

Plant cultivation method in accordance with the invention comprises at least one LED and at least one remote phosphoric material in a remote phosphor up-conversion unit for wavelength conversion and a mechanical trunk and is characterized by the following steps,
a plurality of LEDs emit light to a remote phosphor up-conversion unit through air, gas and/or free space,
said remote phosphor up-conversion unit receives light emission from said plurality of LEDs,
said remote phosphor up-conversion unit absorbs said light emission and up converts said emission to longer wavelengths,
said emission from said plurality of LEDs and/or said up-converted emission is directed to at least one plant.

In addition and with reference to the aforementioned advantage accruing embodiments, the best mode of the invention is considered to be a large ceiling attached lighting device for greenhouses that has a replaceable cover glass in which phosphoric materials are embedded, thereby making the cover glass the remote phosphor up-conversion unit. The LED emitters are also replaceable, attached to the trunk, and not a circuit board in the best mode. The distance between the plurality of LEDs and the remote phosphor unit is configured so that the temperature of the remote phosphor up-conversion unit is 40±10 C.°, and said LED is at 130±30 C.° temperature in the best mode.

### BRIEF DESCRIPTION OF THE DRAWINGS

In the following the invention will be described in greater detail with reference to exemplary embodiments in accordance with the accompanying drawings, in which

FIG. 1A demonstrates an embodiment 10 of the inventive light transmitter as a block diagram from the side.

FIG. 1B demonstrates an embodiment 10 of the light emitting surface of the light transmitter of FIG. 1A as a block diagram viewed from the bottom of FIG. 1A.

FIG. 2 demonstrates an embodiment 20 of the plant cultivation method in accordance with the invention as a flow diagram.

FIG. 3 demonstrates an embodiment 30 of the horticultural light device in accordance with the invention in a greenhouse environment.

FIG. 4 demonstrates an embodiment 100 of the horticultural phosphor up-conversion unit in accordance with the invention.

FIG. 5 demonstrates an embodiment 101 of the horticultural light device in accordance with the invention with ray diagrams.

Some of the embodiments are described in the dependent claims.

### DETAILED DESCRIPTION OF EMBODIMENTS

FIG. 1A demonstrates the horticultural lighting system of the invention from the side as a block diagram. The lighting system 10 is typically realised into a mechanical trunk 12 and attached to the roof of the greenhouse from holes 11 that are in the trunk of the horticultural light. Naturally other mechanical fixtures are also possible in accordance with the invention. The horticultural light typically has a power source and/or a battery 20. It is likely that reasonably high powers are being used in the horticultural light, and in some embodiments cooling elements 30 may be integrated into the horticultural light 10 to assist in the convective and conductive cooling of the horticultural light.

The horticultural light 10 typically has a plurality of LED (Light Emitting Diode) emitters 50, 51, 52, 53, 54 and/or 55. These LED emitters 50, 51, 52, 53, 54 and/or 55 are identical in some embodiments. In other embodiments the LED emitters could be different 50, 51, 52, 53, 54 and/or 55. For example, in some embodiments some emitters may have different transmission powers and/or different spectral shapes in their emission spectrum. The LED emitters 50, 51, 52, 53, 54 and/or 55 are housed underneath the remote phosphor unit 40, which is typically a cover glass somewhat distant from the LED emitters 50, 51, 52, 53, 54 and/or 55.

FIG. 1B demonstrates a bottom view, showing LED emitters 50, 51, 52, 53, 54 and/or 55 behind the remote phosphor unit 40. The remote phosphor unit is typically realised as a cover glass, which is transparent to some wavelengths. For example, in one embodiment the remote phosphor unit is transparent to blue light, and the LED emitters 50, 51, 52, 53, 54 and/or 55 are configured to transmit blue light. A portion of the emitted light passes through the remote phosphor unit 40, but some portion of the blue light will also become up converted into red light. In addition to LED emitters 50, 51, 52, 53, 54 and/or 55 there are two further rows of LED emitters, namely LED emitter rows 60 and 70 behind the remote phosphor unit 40.

The plurality of LEDs 50, 51, 52, 53, 54, 55, 60 and/or 70 and the remote phosphor up-conversion unit 40 are typically configured to be separated by air, gas and/or free space, which is shown in FIG. 1A as separation 41. The remote phosphor up-conversion unit 40 is configured to receive light emission from said plurality of LEDs 50, 51, 52, 53, 54, 55, 60 and/or 70, which emit light downward, and inevitably their photon emission hits the remote phosphor up-conversion unit 40. The remote phosphor up-conversion unit 40 is configured to absorb all or part of the light emission from the LEDs 50, 51, 52, 53, 54, 55, 60 and/or 70 and up convert all or part of this emission to longer wavelengths. The emission from said plurality of LEDs 50, 51, 52, 53, 54, 55, 60 and/or 70, and/or said up-converted emission emitted by the remote phosphor unit 40 is configured to be emitted on at least one plant, which in FIG. 1A would be positioned beneath the horticultural light 10.

The remote phosphor unit 40 is typically a cover glass that has one or more phosphoric materials 45, 46 embedded into it. In some embodiments photons from all or some LEDs 50, 51, 52, 53, 54, 55, 60 and/or 70 can reach e.g. the phosphoric material 45 and/or 46. In some preferable embodiments the horticultural light 10 is configured so with the output power and the separation 41 and possibly other parameters that the remote phosphor unit 40 operates at a temperature of 40±10 C.°, and said LEDs 50, 51, 52, 53, 54, 55, 60 and/or 70 operate at a temperature of 130±30 C.° at the standard power output of the horticultural light, in equilibrium. The aforementioned temperatures are preferable, because they are the respective optimums of the remote phosphor unit 40 and LEDs 50, 51, 52, 53, 54, 55, 60 and/or 70, respectively.

In some embodiments the output power of the LEDs 50, 51, 52, 53, 54, 55, 60 and/or 70 and the length of the separation 41 can be controlled with respect to other variables, such as the greenhouse temperature or other ambient temperature. In this embodiments the power supplied to the LEDs 50, 51, 52, 53, 54, 55, 60 and/or 70 could be determined by a temperature measuring apparatus. Similarly the separation 41 could be controlled by an engine and e.g. hydraulics, or the separation 41 could be manually controlled by screws or other mechanical positioning solution.

In some embodiments the remote phosphor up-conversion unit 40 is configured to be replaced with a second remote phosphor up-conversion unit. This can be used to change the aggregate emission spectrum of the horticultural light 10 without interfering with the LEDs 50, 51, 52, 53, 54, 55, 60 and/or 70. This results when the second remote phosphor up-conversion unit (not shown) is configured with different optical emission properties to the first remote phosphor up-conversion unit 40.

In some embodiments all or some of the said plurality of LEDs 50, 51, 52, 53, 54, 55, 60 and/or 70 are physically attached to and physically in contact with the mechanical trunk 12 of the horticultural light. In this embodiment, the mechanical trunk sometimes excludes any circuit board and/or breadboard for electrical connections. Wiring the LEDs directly to the trunk 12 saves the cost of the circuit board, and reduces the weight of the horticultural lighting device 10.

In some embodiments of the invention all or some of the said plurality of LEDs 50, 51, 52, 53, 54, 55, 60 and/or 70 are any of the following: AlInGaP—, AlInGaN—, AlGaAs—, and/or InGaN— LED. In some embodiments of the invention said plurality of LED emitters 50, 51, 52, 53, 54, 55, 60 and/or 70 comprises LED emitters configured to transmit different emission spectra: e.g. LED emitters 50, 51, 52, 53, 54, 55 could emit blue light and LED emitter row 60 could emit red light in some embodiments of the invention.

In some embodiments of the invention the phosphoric material 45, 46 embedded into the cover glass, resulting to the remote phosphor up-conversion unit 40, is any of the following: BaMgAI₁₀O₁₇:Eu²⁺, (Sr,Ba,Ca)₅(PO₄)₃ Cl:Eu²⁺ and BaMg₂AI₁₆O₂₇:Eu²⁺, La₃Si₆N₁₁:Ce³⁺, SrSiAI₂O₃N₂:Ce³⁺, YAG:Ce³⁺ and/or quantum dot.

It should also further be noted that the embodiment 10 can be readily permuted and/or combined with any of the embodiments 20, 30, 100 and/or 101 in accordance with the invention.

Furthermore any light spectrum from WO 2011/033177, of the inventor and applicant can be combined with embodiment 10. This document is cited here as reference.

FIG. 2 demonstrates a plant cultivation method 20 that operates with at least one LED 50, 51, 52, 53, 54, 55, 60 and/or 70 and at least one remote phosphoric material 45, 46 in a remote phosphor up-conversion unit 40 for wavelength conversion. Both the LEDs 50, 51, 52, 53, 54, 55, 60 and/or 70 and the remote phosphor up-conversion unit are realised into a mechanical trunk 12.

In phase 200 a plurality of LEDs 50, 51, 52, 53, 54, 55, 60 and/or 70 emit light. The LEDs 50, 51, 52, 53, 54, 55, 60 and/or 70 are preferably maintained at a temperature of 130±30 C.° in some embodiments. In order to get to this optimum temperature in some embodiments the said plurality of LEDs 50, 51, 52, 53, 54, 55, 60 and/or 70 is physically attached to and physically in contact with the mechanical trunk 12 of the horticultural light. In this case in some embodiments the mechanical trunk 12 excludes any circuit board and/or breadboard for electrical connections, and the emitting LEDs 50, 51, 52, 53, 54, 55, 60 and/or 70 are just wired to the trunk 12.

It is also possible that any of the said LEDs 50, 51, 52, 53, 54, 55, 60 and/or 70 is any of the following: AlInGaP—, AlInGaN—, AlGaAs—, and/or InGaN— LED. The plurality of LED emitters comprises LED emitters transmitting different emission spectra from one another in some embodiments. For example LED emitter 50 could be emitting red light whereas LED emitter 55 could be emitting blue light in some embodiments.

In phase 210 the emitted light passes through air, gas and/or free space to a remote phosphor up-conversion unit 40. The remote phosphor up-conversion unit 40 receives light emission from said plurality of LEDs 50, 51, 52, 53, 54, 55, 60 and/or 70.

In phase 220 the remote phosphor up-conversion unit 40 absorbs said light emission and up-converts all or part of said emission to longer wavelengths. The remote phosphor up-conversion unit 40 or the phosphoric material 45, 46 therein is preferably maintained at an operational temperature of 40±10 C.° in some embodiments. The phosphoric material 45, 46 in the remote phosphor up-conversion unit 40 may be any of the following: BaMgAI₁₀O₁₇:Eu²⁺, (Sr,Ba,Ca)₅(PO₄)₃ Cl:Eu²⁺ and BaMg₂AI₁₆O₂₇:Eu²⁺, La₃Si₆N₁₁:Ce³⁺, SrSiAI₂O₃N₂:Ce³⁺, YAG:Ce³⁺ and/or quantum dot.

In phase 230 said emissions from said plurality of LEDs and/or said up-converted emission is directed to at least one plant. The emission from the plurality of LEDs and the up-converted emission, in combination, produce a modified emission spectrum that has one or both components. If both components exist, as in many preferable embodiments, the relative intensities of the components need not be the same.

In phase 240 the modified emission spectrum is absorbed by at least one plant.

In some embodiments of the inventive method, the remote phosphor up-conversion unit 40 is mechanically replaced with a second remote phosphor up-conversion unit. The second remote phosphor up-conversion unit absorbs and emits light differently to the replaced remote phosphor up-conversion unit, and spectrum of emitted light changes due to said replacement. Otherwise, the phases 200-240 are just repeated with the second remote phosphor up-conversion unit.

It should also further be noted that the embodiment 20 can be readily permuted and/or combined with any of the embodiments 10, 30 and/or 100, 101 in accordance with the invention.

Furthermore any light spectrum from WO 2011/033177, of the inventor and applicant can be combined with embodiment 20. This document is cited here as reference.

FIG. 3 demonstrates an embodiment 30 of the use of the horticultural light 10 in greenhouse plant cultivation. In this exemplary embodiment 30, the plants 5, 6, and 7 are inside a greenhouse 350. The greenhouse 350 is typically transparent to all or some of the solar light outside. The horticultural lights 10 and 9 are suspended from the roof of the greenhouse by a wire 1 underneath a reflector 2. Horticultural light 9 may be identical to horticultural light 10 in some embodiments.

The horticultural lights 3 and 4, which may be identical to embodiment 10 in some embodiments, are suspended from the floor of the greenhouse with a pole 400, and the reflector 402 is beneath the horticultural lights in this embodiment.

During daytime the plants 5, 6, and 7 received the emission spectra from the horticultural lights 3, 4, 9 and 10 and the sun. During night, only the horticultural lights 3, 4, 9 and 10 are used. In some embodiments there is a replaceable remote phosphor up-conversion unit 40 for night and a second replaceable remote phosphor up-conversion unit for the day. The remote phosphor up-conversion unit is simply changed at sunrise and at sunset in accordance with the invention. In some embodiments the horticultural lights 3, 4, 9 and 10 can be rotated with an engine to better focus their emission pattern on plants 5, 6, and 7.

Furthermore any light spectrum from WO 2011/033177, of the inventor and applicant can be combined with embodiment 30. This document is cited here as reference.

It should also further be noted that the embodiment 30 can be readily permuted and/or combined with any of the embodiments 10, 20, 100 and/or 101 in accordance with the invention.

FIG. 4 demonstrates an embodiment 100 of the remote phosphor up-conversion unit 440. The remote phosphor up-conversion 440 is typically placed over an array of LED emitters. In embodiment 100 the light from the LEDs arrives from the direction of the arrow, i.e. top of page. The phosphoric materials 47, 48, 49 are arranged into layers within the remote phosphor up-conversion unit 440, which is typically made from glass or plastic. Having separate consecutive phosphoric layers 47, 48, 49 has the added benefit of producing a steady up-converted spectrum. If different phosphoric materials 47, 48 and 49 are mixed into one layer, the mixture will not be uniform, because the different phosphoric materials 47, 48, 49 will form higher and lower density regions, due to their different particle sizes. In other words, the phosphoric materials 47, 48, 49 tend to form clumps in a mixture. A clumpy mixture will produce more up-converted light in the up-conversion wavelength of the clump near the clump, and will lead to non-uniform up-conversion spectrum in the spatial domain.

In embodiment 100, the light emitted by the LEDs is first up-converted by phosphoric material 49, which will also be transparent to a portion of the LED emitted light. The phosphoric material 48 will then receive transparent LED emitted light and up-converted light (by phosphoric material 49). The phosphoric material 48 will then up-convert this combined spectrum, or a part thereof. In addition, the phosphoric material 48 will be transparent to a portion of the incoming spectrum, which is the combined LED transmitted light and light up-converted by phosphoric material 49. Phosphoric material 47 will then up-convert a portion of the spectrum that is transparent through phosphoric material 48 or up-converted by it.

This allows very fine spectral tuning of the remote phosphor up-conversion unit 440, and guarantees that the same spectrum is produced in all regions of the remote phosphor up-conversion unit.

Furthermore any light spectrum from WO 2011/033177, of the inventor and applicant can be combined with embodiment 100. This document is cited here as reference.

It should also further be noted that the embodiment 100 can be readily permuted and/or combined with any of the embodiments 10, 20, 30 and/or 101 in accordance with the invention.

FIG. 5 demonstrates an embodiment 101 of the horticultural light device with ray diagrams. In this embodiment a reflector 90 is placed between the LED emitters 57, 58. A remote phosphor up-conversion unit 440 is placed in front of the LED emitters 57, 58. This could also be the remote phosphor up-conversion unit 40, (not shown).

The remote phosphor up-conversion unit 440, 40 will almost inevitably reflect a part of the Light emission from the LEDs 57, 58 back towards the LEDs 57, 58, as shown by the Reflected light emission arrow in FIG. 5. The reflector 90 is typically placed so, that it covers all areas where it does not block the Light emission by the LEDs 57, 58. In this embodiment 101 the reflector 90 is placed in between the LEDs 57, and 58. The reflector 90 reflects the Reflected light emission back to the remote phosphor up-conversion unit 440. This improves the efficiency of the horticultural light, as more emitted light is directed out from the horticultural light towards the plants and internal reflections are minimised. The reflector 90 is also occasionally referred to as a mixing chamber. The reflector 90 is typically made from mirror foil.

In some embodiments the side of the remote phosphor up-conversion unit 440 incident to the emitted LED light is also covered with an antireflection coating to further improve the efficiency of the horticultural light.

Furthermore any light spectrum from WO 2011/033177, of the inventor and applicant can be combined with embodiment 101. This document is cited here as reference.

It should also further be noted that the embodiment 101 can be readily permuted and/or combined with any of the embodiments 10, 20, 30 and/or 100 in accordance with the invention.

The invention has been explained above with reference to the aforementioned embodiments and several commercial and industrial advantages have been demonstrated. The methods and arrangements of the invention allow great synergistic advantages. The combination of being able to control a separation between the remote phosphor up-conversion unit and the LEDs and having multiple LEDs emit to a single remote phosphor up-conversion unit has a great synergistic advantage: this provides a very energy efficient way of designing complex emission spectra that can be used on an industrial scale. These inventive horticultural lights are also far cheaper to produce as they can be produced from more fundamental raw materials, namely just diodes and phosphoric material. The cost of raw diodes and raw phosphoric material is considerably smaller than producing a horticultural light from lighting subcomponents that have any level of system integration in them. The laminar structure of the remote phosphor up-conversion unit produces a spatially homogeneous emission spectrum, which is very desirable in horticultural applications, where the plant should receive the same spectrum all over itself. The direct wiring of LEDs makes the invention very price competitive on an industrial scale. The reflectors in between the LEDs that reflect backscattered or reflected light back into the remote phosphor up-conversion unit increases the power efficiency of the horticultural light further still by providing optical feedback. The inventive differences and advantages bring about one single synergistic advantage that is greater than the sum of its parts: The invention amounts to an industrially scalable high power efficiency agricultural lighting system that can be used with very high spatial spectral definition in a robust way that involves less components than prior art systems.

The invention has been explained above with reference to the aforementioned embodiments. However, it is clear that the invention is not only restricted to these embodiments, but comprises all possible embodiments within the spirit and scope of the inventive thought and the following patent claims.

### REFERENCES

WO 2011/033177, “Lighting Assembly”, Lars Aikala.
US 2009/0231832 A1, “SOLID-STATE LAMPS WITH COMPLETE CONVERSION IN PHOSPHORS FOR RENDERING AN ENHANCED NUMBER OF COLORS”, A. Zukauskas et. al.
US 2006/0245174A1, “METHOD AND SYSTEM FOR FEEDBACK AND CONTROL OF A LUMINAIRE”, I. Ashdown.
“Improved Performance White LED”, Fifth International Conference on Solid State Lighting, Proceedings of SPIE 5941, 45-50, Bellingham Wash.: International Society of Optical Engineers, N. Narendran, 2005.
WO2010/053341, “Phosphor conversion light-emitting diode for meeting photomorphogenetic needs of plants”, A. Zukauskas, P. Duchovskis, 2010.

1. Horticultural light (3, 4, 9 and 10) comprising at least one LED (50, 51, 52, 53, 54, 55, 57, 58, 60 and/or 70) and at least one remote phosphoric material (45, 46, 47, 48 and 49) in a remote phosphor up-conversion unit (40, 440) for wavelength conversion and a mechanical trunk (12), characterised in that,
a plurality of LEDs (50, 51, 52, 53, 54, 55, 57, 58, 60 and/or 70) and a remote phosphor up-conversion unit (40, 440) are configured to be separated (41) by air, gas and/or free space,
said remote phosphor up-conversion unit (40, 440) is configured to receive light emission from said plurality of LEDs (50, 51, 52, 53, 54, 55, 57, 58, 60 and/or 70), and
said remote phosphor up-conversion unit (40, 440) is configured to absorb said light emission and up convert said emission to longer wavelengths,
said emission from said plurality of LEDs (50, 51, 52, 53, 54, 55, 57, 58, 60 and/or 70) and/or said up-converted emission is configured to be emitted on at least one plant (5, 6, and 7).

2. Horticultural light as claimed in claim 1, characterised in that, said phosphoric material (45, 46, 47, 48 and 49) is configured to operate at a temperature of 40±10 C.°, and said LED (50, 51, 52, 53, 54, 55, 57, 58, 60 and/or 70) is configured to operate at a temperature of 130±30 C.°.

3. Horticultural light as claimed in claim 1, characterised in that, the remote phosphor up-conversion unit (40, 440) is configured to be replaced with a second remote phosphor up-conversion unit.

4. Horticultural light as claimed in claim 3, characterised in that, the second remote phosphor up-conversion unit is configured with different optical emission properties and the emitted spectrum by the horticultural light (3, 4, 9 and 10) is configured to be changed with said replacement of the remote phosphor up-conversion unit (40, 440).

5. Horticultural light as claimed in claim 1, characterised in that, said plurality of LEDs (50, 51, 52, 53, 54, 55, 57, 58, 60 and/or 70) is physically attached to and physically in contact with the mechanical trunk (12) of the horticultural light (3, 4, 9 and 10), and/or
the mechanical trunk (12) excludes any circuit board and/or breadboard for electrical connections.

6. Horticultural light as claimed in claim 1, characterised in that, the said LED (50, 51, 52, 53, 54, 55, 57, 58, 60 and/or 70) is any of the following: AlInGaP—, AlInGaN—, AlGaAs—, and/or InGaN— LED.

7. Horticultural light as claimed in claim 1, characterised in that, the said phosphoric material (45, 46, 47, 48 and 49) is any of the following: BaMgAI₁₀O₁₇:Eu²⁺, (Sr,Ba,Ca)₅(PO₄)₃ Cl:Eu²⁺ and BaMg₂AI₁₆O₂₇:Eu²⁺, La₃Si₆N₁₁:Ce³⁺, SrSiAI₂O₃N₂:Ce³⁺, YAG:Ce³⁺ and/or quantum dot.

8. Horticultural light as claimed in claim 1, characterised in that, said plurality of LED emitters (50, 51, 52, 53, 54, 55, 57, 58, 60 and/or 70) comprises LED emitters configured to transmit different emission spectra.

9. Horticultural light as claimed in claim 1, characterised in that, the separation (41) from the LED emitters (50, 51, 52, 53, 54, 55, 57, 58, 60 and/or 70) to the remote phosphor up-conversion unit (40, 440) is configured to be changed manually or with an engine.

10. Horticultural light as claimed in claim 1, characterised in that, the remote phosphor up-conversion unit (40, 440) comprises at least one laminar layer of phosphoric material (47, 48 and 49).

11. Horticultural light as claimed in claim 10, characterised in that, the remote phosphor up-conversion unit (40, 440) comprises at least two laminar layers of phosphoric material (47, 48 and 49) arranged so that the phosphoric materials with same particle sizes are in the same layer.

12. Horticultural light as claimed in claim 1, characterised in that, at least one reflector (90) is arranged to reflect light into the remote phosphor up-conversion unit (40, 440).

13. Plant cultivation method comprising at least one LED (50, 51, 52, 53, 54, 55, 57, 58, 60 and/or 70) and at least one remote phosphoric material (45, 46, 47, 48 and 49) in a remote phosphor up-conversion unit (40, 440) for wavelength conversion and a mechanical trunk (12), comprising the following steps,
a plurality of LEDs (50, 51, 52, 53, 54, 55, 57, 58, 60 and/or 70) emit light to a remote phosphor up-conversion unit (40, 440) through air, gas and/or free space (41),
said remote phosphor up-conversion unit (40, 440) receives light emission from said plurality of LEDs (50, 51, 52, 53, 54, 55, 57, 58, 60 and/or 70),
said remote phosphor up-conversion unit (40, 440) absorbs said light emission and up-converts said emission to longer wavelengths,
said emission from said plurality of LEDs (50, 51, 52, 53, 54, 55, 57, 58, 60 and/or 70) and/or said up-converted emission is directed to at least one plant (5, 6, and 7).

14. Plant cultivation method as claimed in claim 13, characterised in that, said at least one phosphoric material (45, 46, 47, 48 and 49) is at an operational temperature of 40±10 C.°, and at least two LEDs (50, 51, 52, 53, 54, 55, 57, 58, 60 and/or 70) are at 130±30 C.°.

15. Plant cultivation method as claimed in claim 13, characterised in that, the remote phosphor up-conversion unit (40, 440) is mechanically replaced with a second remote phosphor up-conversion unit.

16. Plant cultivation method as claimed in claim 15, characterised in that, the second remote phosphor up-conversion unit absorbs and emits light differently to the replaced remote phosphor up-conversion unit (40, 440), and spectrum of emitted light changes due to said replacement.

17. Plant cultivation method as claimed in claim 13, characterised in that, said plurality of LEDs (50, 51, 52, 53, 54, 55, 57, 58, 60 and/or 70) is physically attached to and physically in contact with the mechanical trunk (12) of the horticultural light (3, 4, 9 and 10), and/or
the mechanical trunk (12) excludes any circuit board and/or breadboard for electrical connections.

18. Plant cultivation method as claimed in claim 13, characterised in that, at least one said LED (50, 51, 52, 53, 54, 55, 57, 58, 60 and/or 70) is any of the following: AlInGaP—, AlInGaN—, AlGaAs—, and/or InGaN— LED.

19. Plant cultivation method as claimed in claim 13, characterised in that, at least one said phosphoric material (45, 46, 47, 48 and 49) is any of the following: BaMgAI₁₀O₁₇:Eu²⁺, (Sr,Ba,Ca)₅(PO₄)₃Cl:Eu²⁺ and BaMg₂AI₁₆O₂₇:Eu²⁺, La₃Si₆N₁₁:Ce³⁺, SrSiAI₂O₃N₂:Ce³⁺, YAG:Ce³⁺ and/or quantum dot.

20. Plant cultivation method as claimed in claim 13, characterised in that, said plurality of LED emitters (50, 51, 52, 53, 54, 55, 57, 58, 60 and/or 70) comprises LED emitters transmitting different emission spectra.

21. Plant cultivation method as claimed in claim 13, characterised in that, the separation (41) from the LED emitters (50, 51, 52, 53, 54, 55, 57, 58, 60 and/or 70) to the remote phosphor up-conversion unit (40, 440) is changed manually or with an engine.

22. Plant cultivation method as claimed in claim 13, characterised in that, the remote phosphor up-conversion unit (40, 440) comprises at least one laminar layer of phosphoric material (47, 48 and 49).

23. Plant cultivation method as claimed in claim 13, characterised in that, the remote phosphor up-conversion unit (40, 440) comprises at least two laminar layers of phosphoric material (47, 48 and 49) and the phosphoric materials with same particle sizes are in the same layer.

24. Plant cultivation method as claimed in, characterised in that, at least one reflector (90) reflects light into the remote phosphor up-conversion unit (40, 440).

25. (canceled)
